(19) United States
(12) Patent Application Publication
(10) Pub. No.: US 2024/0264567 A1
(43) Pub. Date: Aug. 8, 2024

(54) PLANETARY CLOCK

(71) Applicant: Andrey Bukayev, Brooklyn, NY (US)

(72) Inventor: Andrey Bukayev, Brooklyn, NY (US)

(21) Appl. No.: 18/107,156

(22) Filed: Feb. 8, 2023

(51) Int. Cl. G04B 19/26

(52) U.S. Cl. CPC G04B 19/262

(57) ABSTRACT

A planetary clock, including a main body to display at least one of a time of day and an expected weather pattern during a course of the day based on a selected planet, a primary planet selector movably disposed on at least a portion of the main body to select a first planet in response to being depressed, and an alternate planet selector movably disposed on at least a portion of the main body to select at least one second planet in response to being depressed.

### BACKGROUND

### 1. Field

The present general inventive concept relates generally to determining time, and particularly, to a planetary clock.

### 2. Description of the Related Art

A weather clock is a type of clock that in addition to providing time information, provides temperature and/or current weather conditions. Moreover, the weather clock is unable to determine how the weather will look for an entire day. Generally, the weather clock uses a barometric sensor to detect changes in atmospheric pressure to predict what the weather will be.

Furthermore, the weather clock only provides time and/or weather on Earth and does not possess capabilities to consider these factors on neighboring planets. For example, the weather clock is does not display time and/or weather on Mars, Venus, and/or Mercury.

Therefore, there is a need for a planetary clock that identifies time and/or weather on Earth as well as at least one other planet.

### SUMMARY

The present general inventive concept provides a planetary clock.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a planetary clock, including a main body to display at least one of a time of day and an expected weather pattern during a course of the day based on a selected planet, a primary planet selector movably disposed on at least a portion of the main body to select a first planet in response to being depressed, and an alternate planet selector movably disposed on at least a portion of the main body to select at least one second planet in response to being depressed.

The main body may include an outer portion to display the expected weather pattern during the course of the day thereon, and an inner portion disposed at a center of the outer portion to display the time of the day thereon.

The planetary clock may further include a planetary track disposed between the outer portion and the inner portion to receive the primary planet selector and the alternate planet selector therein and facilitate movement of the primary planet selector and the alternate planet selector.

The main body may be a touchscreen display.

The planetary clock may further include a plurality of time hands disposed on at least a portion of a center of the main body to display the time of the day.

The planetary clock may further include a solar selector disposed on at least a portion of a center of the main body to identify a position of an actual planet using a position of at least one of the primary planet selector and the alternate planet selector.

The planetary clock may further include a control unit disposed within at least a portion of the main body to receive planetary data from an external device, and determine at least one of the time of the day and the expected weather pattern based on a location selected from the selected planet.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a planetary clock, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Planetary Clock 100
Main Body 100
Outer Portion 111
Inner Portion 112
Primary Planet Selector 120
Alternate Planet Selector 130
Planetary Track 140
Time Hands 150
Hour Hand 151
Minute Hand 152
Solar Selector 160
Control Unit 170
Processing Unit 171
Communication Unit 172
Storage Unit 173
Power Source 180

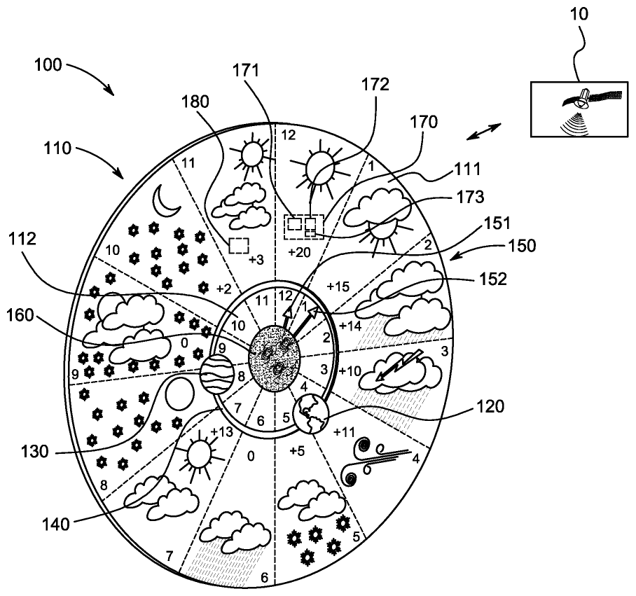

FIG. 1 illustrates a front perspective view of a planetary clock 100, according to an exemplary embodiment of the present general inventive concept.

The planetary clock 100 may be constructed from at least one of metal, plastic, wood, and rubber, etc., but is not limited thereto.

The planetary clock 100 may include a main body 110, a primary planet selector 120, an alternate planet selector 130, a planetary track 140, a plurality of time hands 150, a solar selector 160, a control unit 170, and a power source 180, but is not limited thereto.

Referring to FIG. 1, the main body 110 is illustrated to have a circular shape and/or a cylindrical shape. However, the main body 110 may be rectangular, triangular, pentagonal, hexagonal, heptagonal, octagonal, or any other shape known to one of ordinary skill in the art, but is not limited thereto.

The main body 110 may be constructed as a fixed surface. More specifically, the main body 110 may have a plurality of time units and/or a plurality of weather patterns illustrated thereon. For example, the main body 110 may have one o'clock, two o'clock, three o'clock, four o'clock, five o'clock, six o'clock, seven o'clock, eight o'clock, nine o'clock, ten o'clock, eleven o'clock, and/or twelve o'clock illustrated thereon. Also, the main body 110 may have a sunny day, a cloudy day, a partially cloudy day, a rainy day, a snowy day, a hail day, a freezing rain day, a windy day, a dust storm day, a thunderstorm day, and/or any other type of weather pattern illustrated thereon.

Alternatively, the main body 110 may include a projector, a plasma screen, an LCD screen, a light emitting diode (LED) screen, an organic LED (OLED) screen, a computer monitor, a hologram output unit, a sound outputting unit, or any other type of device that visually or aurally displays data.

Moreover, the main body 110 may be integrated with an input unit, such that the main body 110 may be a touch-screen. Furthermore, the main body 110 may be disposed and/or removably connected on a surface, such as a table, a desk, a countertop, a wall (e.g., via a hook), etc.

The main body 110 may include an outer portion 111 and an inner portion 112, but is not limited thereto.

The main body 110 may display the plurality of time units and/or the plurality of weather patterns thereon. More specifically, the main body 110 may display the plurality of time units (e.g., hour, minute, seconds) and/or the plurality of weather patterns based on a selected planet, location, and/or area of the selected planet. As such, the main body 110 may display a time of day, an expected weather pattern during a course of the day and/or based on the location of the selected planet.

The outer portion 111 may be circumferentially disposed (i.e., in a circle) on at least a portion of a perimeter of the main body 110. The outer portion 111 may display the plurality of time units and/or the plurality of weather patterns thereon.

The inner portion 112 may be disposed on at least a portion of a center of the outer portion 111. In other words, the inner portion 112 may be disposed at a center of the main body 110. Also, the inner portion 112 may have a size (e.g., a diameter, a circumference) less than a size (e.g., a diameter, a circumference) of the outer portion 111. The inner portion 112 may display the plurality of time units thereon.

The primary planet selector 120 may be movably (i.e., slidably, rotatably) disposed on at least a portion of the outer portion 111 and/or the inner portion 112 between the outer portion 111 and/or the inner portion 112. The primary planet selector 120 may select a first planet (e.g., Earth) in response to being depressed. The inner portion 112 may display the time of day (i.e., a current time) in real time in response to the primary planet selector 120 being depressed. Additionally, the outer portion 111 may display the expected weather pattern during the course of the day in response to the primary planet selector 120 being depressed. Also, the expected weather pattern may be updated and/or display on the outer portion 111 based on weather changes in real time.

The alternate planet selector 130 may be movably (i.e., slidably, rotatably) disposed on at least a portion of the outer portion 111 and/or the inner portion 112 between the outer portion 111 and/or the inner portion 112. The alternate planet selector 130 may select at least one second planet (e.g., Mars, Venus, Mercury, Jupiter, Saturn, Uranus, Neptune, Pluto) in response to being depressed. The inner portion 112 may display the time of day (i.e., a current time) in real time in response to the alternate planet selector 130 being depressed. Additionally, the outer portion 111 may display the expected weather pattern during the course of the day in response to the alternate planet selector 130 being depressed.

The planetary track 140 may be disposed between the outer portion 111 and/or the inner portion 112. The planetary track 140 may receive and/or connect to the primary planet selector 120 and/or the alternate planet selector 130. Moreover, the primary planet selector 120 and/or the alternate planet selector 130 may move (i.e., slide, rotate) along at least a portion of the planetary track 140 and/or an entirety of the planetary track 140. In other words, the planetary track 140 may facilitate movement of the primary planet selector 120 and/or the alternate planet selector 130 across the planetary track 140. The position of the primary planet selector 120 and/or the alternate planet selector 130 may be based on real time positioning of an actual planet corresponding to the selected planet for the primary planet selector 120 and/or the alternate planet selector 130.

The plurality of time hands 150 may include an hour hand 151 and a minute hand 152, but is not limited thereto.

The hour hand 151 may be movably (i.e., rotatably) disposed on at least a portion of a center of the inner portion 112. The hour hand 151 may identify a current hour of the day based on a planet selection and/or a location on the planet as described above. The hour hand 151 may move (i.e., rotate) based on changes in time.

The minute hand 152 may be movably (i.e., rotatably) disposed on at least a portion of the center of the inner portion 112. The minute hand 152 may identify a current minute of the day based on the planet selection and/or the location on the planet as described above. The minute hand 152 may move (i.e., rotate) based on changes in time.

Thus, collectively, the hour hand 151 and/or the minute hand 152 may display the time of day.

The solar selector 160 may be disposed on at least a portion of the center of the inner portion 112. The solar selector 160 may select a star (i.e., the Sun) in response to being depressed. The outer portion 111 and/or the inner portion 112 may display information of the star (e.g., the Sun) based on current information received from an external device 10, such as a satellite, a data center, a weather service, a government agency, etc. The outer portion 111 and/or the inner portion 112 may display status of the Sun, such as solar flares, coronal mass ejections (CME), and/or solar storms.

It is important to note that the primary planet selector 120 and/or the alternate planet selector 130 may move around the solar selector 160 based on current (i.e., real time) positioning of each actual planet. For example, revolution and/or positioning of the Earth and/or Mars around the Sun may be accurately depicted between the primary planet selector 120 and/or the alternate planet selector 130 with respect to the solar selector 160. Thus, the solar selector 160 may identify a position of an actual planet using a position of at least one of the primary planet selector 120 and the alternate planet selector 130.

The control unit 170 may include a processing unit 171, a communication unit 172, and a storage unit 173, but is not limited thereto.

The processing unit 171 (or central processing unit, CPU) may include electronic circuitry to carry out instructions of a computer program by performing basic arithmetic, logical, control and input/output (I/O) operations specified by the instructions. The processing unit 171 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 171 may also include a microprocessor and a microcontroller.

The communication unit 172 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 173 may include a random access memory (RAM), a read-only memory (ROM), a hard disk, a flash drive, a database connected to the Internet, cloud-based storage, Internet-based storage, or any other type of storage unit.

The control unit 170 may access the Internet via the communication unit 172 to allow at least one user to access a website, and/or may allow a software application to be executed using the processing unit 172. For ease of description, the software application will be hereinafter referred to as an app. The app may be downloaded from the Internet to be stored on the storage unit 173.

The processing unit 171 executing the app may command the communication unit 172 to receive planetary data from the external device 10. Thus, the storage unit 173 may store the planetary data thereon. More specifically, the communication unit 172 may receive the time of the day and/or the expected weather pattern during the course of the day for each actual planet. Moreover, the processing unit 171 executing the app may determine the time of the day and/or the expected weather pattern based on a location of the communication unit 172 (e.g., via GPS).

Alternatively, the processing unit 171 executing the app may change and/or update the main body 110 to display the selected planet, such that an area of the selected planet may be selected (e.g., via touchscreen input). Accordingly, the outer portion 111 may display the expected weather pattern based on the area that has been selected and/or the inner portion 112 may display the time of the day at the area that has been selected.

For example, the primary planet selector 120 may be depressed to select Earth, such that the processing unit 171 may update the outer portion 111 and/or the inner portion 112 to receive further input. Moreover, the processing unit 171 may update the outer portion 111 to display an image of the selected planet (i.e., Earth) to query for an area for selection. Accordingly, the processing unit 171 may update the outer portion 111 to display the area for selection, such that the outer portion 111 may display the expected weather pattern for New York and/or the inner portion 112 may display the time of day for New York in response to the outer portion 111 receiving New York as input for the area for selection. Other areas may be selected accordingly based on information presented by the outer portion 111 and/or the inner portion 112.

The power source 180 may include a power inlet, a battery, a wireless charger, and a solar cell, but is not limited thereto.

The power source 180 may be disposed within at least a portion of the outer portion 111 and/or the inner portion 112. The power source 180 may provide power to the outer portion 111, the inner portion 112, the primary planet selector 120, the alternate planet selector 130, the planetary track 140, the plurality of time hands 150, the solar selector 160, and/or the control unit 170. The power source 180 may charge the battery in response to receiving power from an external power source (e.g., a power outlet, wireless power unit) and/or receiving light from an external light source via the solar cell.

Therefore, the planetary clock 100 may provide time and/or weather information for Earth and/or another planet. Also, the planetary clock 100 may provide the time and/or the weather information based on a specific location of the selected planet.

The present general inventive concept may include a planetary clock 100, including a main body 110 to display at least one of a time of day and an expected weather pattern during a course of the day based on a selected planet, a primary planet selector 120 movably disposed on at least a portion of the main body 110 to select a first planet in response to being depressed, and an alternate planet selector 130 movably disposed on at least a portion of the main body 110 to select at least one second planet in response to being depressed.

The main body 110 may include an outer portion 111 to display the expected weather pattern during the course of the day thereon, and an inner portion 112 disposed at a center of the outer portion 111 to display the time of the day thereon.

The planetary clock 100 may further include a planetary track 140 disposed between the outer portion 111 and the inner portion 112 to receive the primary planet selector 120 and the alternate planet selector 130 therein and facilitate movement of the primary planet selector 120 and the alternate planet selector 130.

The main body 110 may be a touchscreen display.

The planetary clock 100 may further include a plurality of time hands 150 disposed on at least a portion of a center of the main body 110 to display the time of the day.

The planetary clock 100 may further include a solar selector 160 disposed on at least a portion of a center of the main body 110 to identify a position of an actual planet using a position of at least one of the primary planet selector 120 and the alternate planet selector 130.

The planetary clock 100 may further include a control unit 170 disposed within at least a portion of the main body 110 to receive planetary data from an external device 10, and determine at least one of the time of the day and the expected weather pattern based on a location selected from the selected planet.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A planetary clock, comprising:
a main body to display at least one of a time of day and an expected weather pattern during a course of the day based on a selected planet;
a primary planet selector movably disposed on at least a portion of the main body to select a first planet in response to being depressed; and
an alternate planet selector movably disposed on at least a portion of the main body to select at least one second planet in response to being depressed.

2. The planetary clock of claim 1, wherein the main body comprises:
an outer portion to display the expected weather pattern during the course of the day thereon; and
an inner portion disposed at a center of the outer portion to display the time of the day thereon.

3. The planetary clock of claim 2, further comprising:
a planetary track disposed between the outer portion and the inner portion to receive the primary planet selector and the alternate planet selector therein and facilitate movement of the primary planet selector and the alternate planet selector.

4. The planetary clock of claim 1, wherein the main body is a touchscreen display.

5. The planetary clock of claim 1, further comprising:
a plurality of time hands disposed on at least a portion of a center of the main body to display the time of the day.

6. The planetary clock of claim 1, further comprising:
a solar selector disposed on at least a portion of a center of the main body to identify a position of an actual planet using a position of at least one of the primary planet selector and the alternate planet selector.

7. The planetary clock of claim 1, further comprising:
a control unit disposed within at least a portion of the main body to receive planetary data from an external device, and determine at least one of the time of the day and the expected weather pattern based on a location selected from the selected planet.
